(19) United States
(12) Patent Application Publication
(10) Pub. No.: US 2008/0141149 A1
(43) Pub. Date: Jun. 12, 2008

(54) FINGER-BASED USER INTERFACE FOR HANDHELD DEVICES

(75) Inventors: Dawson Yee, Bellevue, WA (US); Ceasar de Leon, Redmond, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/608,157

(22) Filed: Dec. 7, 2006

(51) Int. Cl. G06F 3/048

(52) U.S. Cl. 715/764

(57) ABSTRACT

A method and system for providing a user interface for a handheld device that can be operated with one hand renders multiple items on the screen of the handheld device that are designed to match the footprint of a thumb or other finger. A user selects an item in the user interface by pressing it with their finger. The handheld interface system receives the user's selection as an area of the screen that the user touched. The handheld interface system determines a probability that each of the multiple items rendered on the screen was the focus of the user's selection. Then, the handheld interface system displays a subsequent screen based on the determined probability.

### BACKGROUND

More and more people are using handheld devices to manage information and stay in touch with others while on the go. For example, mobile telephones allow people to make telephone calls from virtually anywhere in the world. Personal digital assistants (PDAs) store contact information, business data, notes, and other information that a person may need while away from their desk. A handheld device is often small enough to fit in a pocket, and therefore it generally has a small screen and input area. Handheld devices cannot use modes of input typically found in a desktop computer. For example, a keyboard is often too bulky to incorporate into a handheld device, and there is not always a surface available for a mouse.

Various user interfaces have been designed for handheld devices to take the place of a mouse and keyboard. Many handheld devices include a pointing device called a stylus. These handheld devices have user interfaces that are similar to desktop user interfaces in which a user points and clicks on icons and menus to select various features of the handheld device. Using a stylus requires two-handed operation, one hand to hold the device and another to hold and use the stylus, and is therefore not ideal for certain situations, such as while driving a car or walking and carrying other objects. A stylus is also easy to lose. Some handheld devices include touch screens that allow a user to touch the item the user wants to select. However, because of the small screen size a user must often use a fingernail to make a very fine selection of one object without accidentally selecting other objects, requiring additional attention and precision from the user. Other touch screen user interfaces reduce the ambiguity of the user's selection by containing large, blocky icons spaced far apart and cannot offer the user as many choices, given the limited screen size of handheld devices. A final type of user interface is a scrolling list, in which a user has controls that move up and down and that can select an item. A scrolling list can be operated with one hand but is not well suited to very large lists, such as a contact list with over 50 contacts, which a user must scroll within for a long time to find an item.

### SUMMARY

A method and system for providing a user interface for a handheld device that can be operated with one hand is provided. The handheld interface system renders multiple items on the screen of the handheld device that are designed to match the footprint of a thumb or other finger. A user selects an item in the user interface by pressing it with their finger to select the item. The handheld interface system receives the user's selection as an area of the screen that the user touched. The handheld interface system determines a probability that each of the multiple items rendered on the screen was the focus of the user's selection. Then, the handheld interface system displays a subsequent screen based on the determined probability.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the handheld interface system in one embodiment.

FIG. 2 is a flow diagram that illustrates the processing of the display interface component of the system in one embodiment.

FIG. 3 is a flow diagram that illustrates the processing of the render display component of the system in one embodiment.

FIGS. 4A and 4B illustrate sequences of display pages of the user interface of the system in one embodiment.

FIG. 5 illustrates a display page of the user interface of the system in one embodiment.

### DETAILED DESCRIPTION

A method and system for providing a user interface for a handheld device that can be operated with one hand is provided. The handheld interface system renders multiple items on the screen of the handheld device that are designed to match the footprint of a thumb or other finger (e.g., round or oval). For example, the items may be icons that represent functions such as calendar, contacts, mail, and so on. A user selects an item in the user interface by pressing it with their finger. The handheld interface system receives the user's selection as an area of the screen that the user touched. For example, the selection may be a set of coordinates representing a box or circle that the screen detected as being touched. The handheld interface system determines a probability that each of the multiple items rendered on the screen was the focus of the user's selection. For example, the handheld interface system may determine the center of the user's selection and calculate the distance to the center of each displayed item, with closer items having higher probabilities. Then, the handheld interface system displays a subsequent screen based on the determined probability. For example, if the handheld interface system determines that the user selected an area centered closest to a contacts icon, then the handheld interface system displays a list of contacts. In this way, the handheld interface system provides a user interface that can be operated with one hand, and can display more items closer together than traditional handheld user interfaces.

In some embodiments, the handheld interface system determines the majority area selected by the user. For example, if a user's selection overlaps two items, but the majority of the area selected by the user overlaps one item, then that item may be determined to be the one the user intended to select. It is not uncommon for a user to touch a larger area of the screen than is taken up by a single icon, and using the majority area allows the handheld interface system to place items closer together while still correctly determining the user's intent when selecting an item. The handheld interface system may also use an area less than a majority to determine a user's selection. For example, if the user's selection overlaps several icons, but overlaps one icon more than others, then that icon may be chosen as the one the user intended to select.

In some embodiments, the handheld interface system uses pressure as an input to resolve ambiguity in a user's selection. The input area of the handheld device may be able to detect the pressure of a user's selection. For example, when a user presses an area of the screen with their thumb, there will be more pressure detected at the some points of the area of the screen touched by the thumb than at others. The handheld interface system uses this information to determine the item the user intended to select. For example, if a user's selection overlaps multiple items, the handheld interface system can select the item closest to the point of maximum pressure. The handheld interface system may use a combination of the techniques described above. For example, the handheld interface system may calculate a score for each item that reflects a combination of the distance from the center of the item to the center of the selection area, the majority area selected, and the point of maximum pressure. Then, the item or items with the highest score can be selected as the item or items the user intended to select.

In some embodiments, the handheld interface system varies the size of items to make it easier to select common items. The handheld interface system may track past selections to determine the most commonly selected items. For example, if a contacts icon, calendar icon, and mail icon are displayed, but the user most often selects the mail icon, then the handheld interface system may render the mail icon larger than the calendar and contacts icons to make it easier for the user to select. The handheld interface system may also vary the placement of the item based on the likelihood that the item will be selected. For example, the most commonly selected items may be placed in the center of the screen while less commonly selected items may be placed in the corners, since the center of the screen is easier to select. The items may also be equal in size and spacing, but an invisible selection area around the item may be increased. For example, if an email icon is most likely to be selected by the user, then the system may consider selections in a greater area around the email icon to be the intended selection by the user, whereas the user may have to touch within a smaller area around less frequently selected icons to select those icons. The system may determine which items are most commonly selected by a variety of methods including based on the user's own selection history, based on the selection history of others, or based on a predefined probability of selection.

In some embodiments, the handheld interface system determines the size or placement of the items based on the number of children of the items in a hierarchy. For example, a contacts interface may group contacts by the first letter of their last names and have an icon for each letter of the alphabet, such that contacts with last names beginning with the letter “a” are accessed by selecting an “a” icon, and so on. The handheld interface system may determine the number of contacts within each group, and icons representing larger groups may be rendered as larger icons to make them easier to select. For example, if many contacts have a last name beginning with the letter “s” then the “s” icon may be larger than other icons, since it is more likely that the user will want the “s” group rather than other groups. This type of icon sizing based on group size can be used for many types of items, such as email folders that contain more email than other email folders. The size and placement may also be determined based on the context of an application. For example, if a user is composing an email message then the system could make the send icon large, predicting that that is the option the user is most likely to select next.

In some embodiments, the handheld interface system dynamically determines groups of items to aid in the user's selection. For example, the handheld interface system may display groups of tasks that the user can perform based on the past frequency of the user's performing those tasks. Frequently performed tasks can be rendered as a group having a larger icon to make that group easier to select. For example, there may be a group of frequently performed tasks such as checking a calendar or reading email, and another group of less frequently performed tasks such as checking available memory or other maintenance tasks. The handheld interface system may also group contacts in a similar way. For example, one group may contain contacts that have been sent a communication by the user within the last seven days, another group of contacts that have been sent a communication within the last two weeks, and so on. Another example is that the user may request to display a list of 100 items, but the system may determine that the screen only has room to display 10 items. In this example, the system can create dynamic groups for displaying the items in a sequence of screens. When the user selects one of the groups, then the next screen shows the user the items within that group. This helps the user to select the correct item, such as when there are too many items to display on one screen.

In some embodiments, the handheld interface system confirms a user's selection by displaying a subsequent screen containing likely targets of the user's selection. For example, an initial screen may contain 50 items. The user may then select an area of the screen that overlaps 10 items. The handheld interface system displays a subsequent screen containing only the 10 items, using larger icons for each of them. The user then selects the intended item again. The handheld interface system can repeat this process until the user's selection only overlaps one item or until the user's intended selection can be determined with sufficient certainty, such as by using the probabilities described above (e.g., based on distance to center, majority area, or pressure). In this way, the handheld interface system can display many items on the screen at once, yet the user is still able to make a precise selection using only their finger.

In some embodiments, the handheld interface system displays the user interface described based on an option set by the user. For example, the handheld interface system may contain multiple user interfaces, such as a user interface for use with a stylus and a user interface for use with a finger, and the user can select between these user interfaces. The user may choose to use a stylus when the user has both hands available to reduce the number of screens that the user has to navigate, but switch to the finger-based user interface when the user wants to use only one hand. This offers the user increased flexibility from a single device, by allowing the user to select the most appropriate user interface for the user's current situation.

The embodiments described above are illustrated in further detail below with reference to the figures.

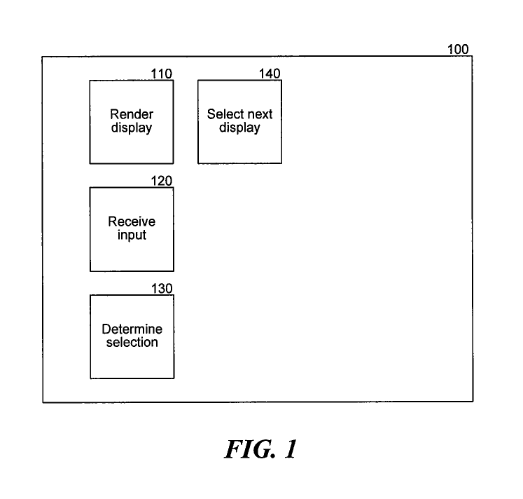

FIG. 1 is a block diagram that illustrates components of the handheld interface system in one embodiment. The handheld interface system 100 contains a render display component 110, a receive input component 120, a determine selection component 130, and a select next display component 140. The render display component 110 renders multiple items to the screen as described above. The render display component 110 may dynamically determine groups for the items and render the groups with a size and placement based on factors such as the past frequency of selection of the items. The receive input component 120 receives an area of selection from a user. For example, the area of selection may be an oval area produced by the shape of the user's thumb where the user touched an area of the screen. The selection may include information such as the coordinates of the area of selection, the pressure applied by the user at each point of the area of selection, and so on. The determine selection component 130 uses the information about the selection from the receive input component 120 to determine which item the user intended to select. The determine selection component 130 may calculate a probability of selection for each item and select the item having the highest probability. The select next display component 140 determines the next screen to be displayed. For example, if the user's selection was so ambiguous the determine selection component 130 could not select a single item, then the select next display component 140 may display a subsequent screen containing the items the user may have intended to select. On the other hand, if the user's selection was unambiguous, then the select next display component 140 may display a screen related to the user's selection, such as the opening screen of an email program if the user selected a mail icon.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

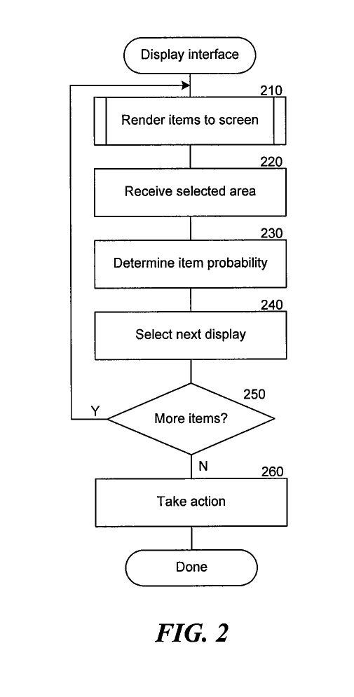

FIG. 2 is a flow diagram that illustrates the processing of the display interface component of the system in one embodiment. The system invokes the display interface component to display the main user interface of the handheld interface system. In step 210, the component renders multiple items to the screen of a handheld device. For example, the component may render a calendar icon, email icon, and contacts icon related to actions that the user can perform by selecting each icon. In step 220, the component receives an area of the screen selected by the user. For example, the selected area may be an oval area of the screen that the user pressed with a thumb. In step 230, the component determines the probability that the user intended to select each of the displayed icons. The probability may be based on various methods, such as the distance from the center of the user's selection to the center of each of the displayed icons. In step 240, the component selects the next screen to be displayed based on the determined probability. For example, the next screen may be selected to confirm the user's selection by displaying the most likely items selected by the user using a larger area of the screen. In decision block 250, if the selected next screen will display more items, then the component loops to block 210 to render the items, else the component continues at block 260. In block 260, an item has been selected and the component takes the action associated with the item. For example, the item may represent an email program and the system may take the action of launching the email program. After block 260, these steps conclude.

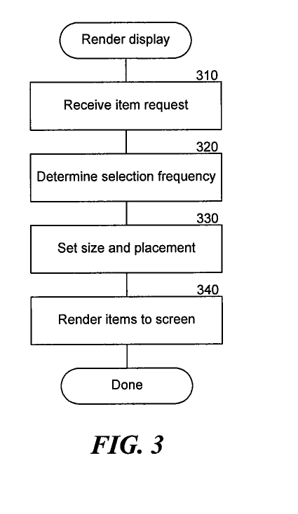

FIG. 3 is a flow diagram that illustrates the processing of the render display component of the system in one embodiment. The component is invoked to render items to the screen of a handheld device. In block 310, the component receives a request to render items to the screen. For example, the request may contain 100 of a user's contacts that are to be rendered to the screen. In block 320, the component determines the selection frequency of each item. For example, one contact may be selected daily, while others may be selected once a week or less frequently. In block 330, the component sets the size and placement of the items based on the determined selection frequency. For example, frequently selected items may be rendered larger and closer to the center of the screen, while less frequently selected items may be rendered smaller and closer to the corners of the screen. The component may also determine that the items should be grouped. For example, the component may render the contacts as work contacts, friends, acquaintances, and so on. In block 340, the component renders the items to the screen of the handheld device. The component then completes.

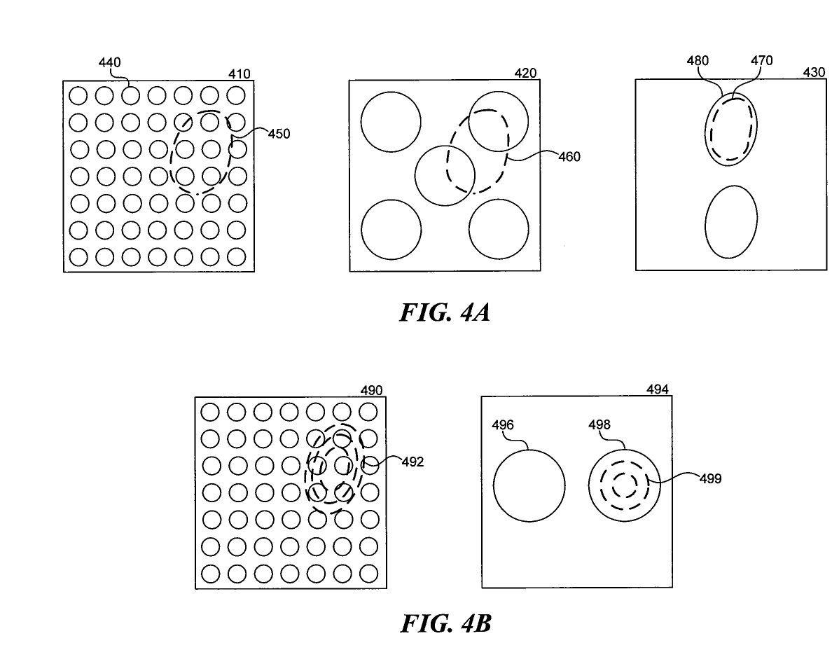

FIGS. 4A and 4B illustrate sequences of display pages of the user interface of the system in one embodiment. FIG. 4A illustrates a first display page 410 containing dozens of small items, such as an item 440. A user selects an area 450 of the display page that overlaps five items. The next display page 420 illustrates a subsequent display containing the overlapped five items from the first display page 410. The user selects an area 460 of display page 420 that overlaps two items. The last display page 430 contains the two items overlapped in the previous display page 420. The user selects an area 470 that only overlaps one item 480. The progression of display pages 410, 420, and 430 illustrates the ability of the system to provide the user with a screen containing many items that the user can select, and then guide the user through as many subsequent screens as needed to confirm the user's selection. The system may determine the user's intended selection before the user-selected area only overlaps one item, such as if the user-selected area substantially overlaps one item.

FIG. 4B is similar to FIG. 4A, but also uses pressure as an input to resolve ambiguity in the selection of an item. The first display page 490 contains dozens of items. A user selects an area 492 of the display that overlaps five items. The selected area 492 contains concentric circles that represent varying levels of pressure detected. For example, the innermost circle represents the area of highest pressure and therefore the likely focal point of the user's selection. The innermost circle is closest to two of the items 496 and 498, which are displayed in the second display page 494 for the user to confirm. The user selects an area 499 that only overlaps item 498. By using pressure information, the system may reduce the number of screens displayed to the user as illustrated by FIGS. 4A and 4B.

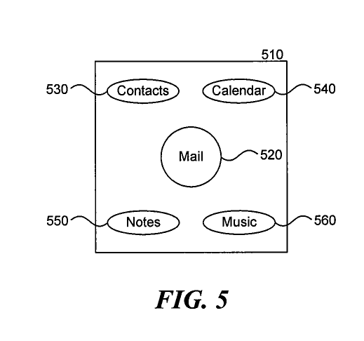

FIG. 5 illustrates a display page of the user interface of the system in one embodiment. The display page 510 illustrates the dynamic sizing and placement of items on the screen based on various factors, such as frequency of selection of the items. The display page 510 contains a mail icon 520, a contacts icon 530, a calendar icon 540, a notes icon 550, and a music icon 560 representing various actions that the user can perform using the handheld device. The mail icon 520 is rendered larger than the other icons and at the center of the screen so that it is easy for the user to select. The size of the icons may be determined by the past frequency of selection of the item represented by the icon, or based on other factors such as an urgency determined for each icon. For example, the mail icon 520 may be larger because a new email has been received that the user should read. As illustrated in FIGS. 4A and 4B, the number of screens that a user navigates to select an item may increase based on the ambiguity of the user's selection. By making certain icons larger, the system can make it more likely that the user only navigates one screen to select common items, whereas the user is less likely to mind navigating multiple screens to select less frequently used items.

From the foregoing, it will be appreciated that specific embodiments of the handheld interface system have been described herein for purposes of illustration, but that various modifications may be made without deviating from the spirit and scope of the invention. For example, although handheld devices have been described, larger devices such as laptops or tablet PCs may contain small auxiliary screens on the back for quick access while on the go that can also use the interface techniques described above. Accordingly, the invention is not limited except as by the appended claims.

I claim:

1. A method in a computer system of selecting items in a handheld device using a finger, the method comprising:
rendering multiple items on a screen of the handheld device;
receiving a selection of an area of the screen that indicates an area of the screen that was touched by the finger;
determining a probability that each item was the target of the selection; and
displaying a subsequent image based on the determined probability.

2. The method of claim 1 wherein the probability is based on the distance from the center of the area of the screen that was touched by the finger to the center of each of the multiple items.

3. The method of claim 1 wherein the probability is based on a majority area selected.

4. The method of claim 1 wherein the probability is based on the pressure applied within the area selected.

5. The method of claim 1 wherein rendering multiple items comprises rendering items with a size based on a probability of being selected.

6. The method of claim 1 wherein rendering multiple items comprises rendering items with a placement based on a probability of being selected.

7. The method of claim 1 wherein rendering multiple items comprises rendering items with a size based on pending actions for each item.

8. The method of claim 1 wherein rendering multiple items comprises rendering items with a size based on the number of children of each item in a hierarchy of items.

9. The method of claim 1 further comprising dynamically determining groups of items and wherein rendering multiple items is based on the determined groups.

10. The method of claim 1 wherein displaying a subsequent image comprises displaying an image containing a subset of the multiple items based on the probability that one of the subset of items was the target of the user's selection.

11. A computer-readable medium containing instructions for controlling a computer system to display items in a user interface of a device based on the frequency of selection of the items, by a method comprising:
providing a group of items to render on a display;
determining a probability of being selected for each item in the group; and
rendering the items on the display in such a way that the items with the highest probability of being selected are easier to select than the items with a lower probability of being selected,
such that items can be selected by a user with one finger.

12. The computer-readable medium of claim 11 wherein determining a probability of being selected comprises determining the past frequency of selection.

13. The computer-readable medium of claim 11 wherein rendering the items on the display comprises determining the size and placement of the items.

14. A computer system for using a handheld device with one hand, comprising:
a render display component configured to render multiple items on a screen of the handheld device;
a receive input component configured to receive a selection of an area of the screen that indicates an area of the screen that was touched by a user;
a determine selection component configured to determine a probability that each item was the target of the selection; and
a select next display component configured to select a subsequent display based on the determined probability.

15. The system of claim 14 wherein the render display component is configured to render multiple items based on a selection by a user among multiple input methods.

16. The system of claim 15 wherein one of the multiple input methods is a stylus.

17. The system of claim 15 wherein one of the multiple input methods is a finger-based input method.

18. The system of claim 14 wherein the determine selection component determines the probability based on a majority area selected.

19. The system of claim 14 wherein the render display component-renders the multiple items with a size and placement based on the past frequency of selection of each item.

20. The system of claim 14 wherein the render display component dynamically determines groups of items and renders the items based on the determined groups.
